(19) United States
(12) Patent Application Publication
(10) Pub. No.: US 2009/0149785 A1
(43) Pub. Date: Jun. 11, 2009

(54) Massage device

(76) Inventors: Enrique Canto Garcia, Alicante (ES); Angel Albir Blasco, Alicante (ES)

Correspondence Address: Thomas L Kautz;Gray Robinson, 401 East Las Olas Blvd Suite 1850, Fort Lauderdale, FL, 33301, US

(21) Appl. No.: 11/990,890

(22) PCT Filed: May 26, 2006
(86) PCT No.: PCT/ES2006/070072

§ 371 Date: Feb. 22, 2008

(30) Foreign Application Priority Data
Aug. 26, 2005 (ES) P200502109

(51) Int. Cl. A61H 7/00

(52) U.S. Cl. 601/99

(57) ABSTRACT

The invention relates to a massage device which is intended for a massage chair, consisting of a support for an eccentric rotating shaft (4), which is equipped with a hole (5) for coupling said shaft thereto and which is joined at an articulation point (6) to a support (1) bearing two massage wheels, namely an upper wheel (2) and a lower wheel (3). The upper wheel (2) is connected to the wheel support (1) by means of a cervical arm (7), such that one end of the arm (7) is articulated with the upper wheel (2), while the other end of the arm is equipped with an articulation point (8) at which it is articulated with the wheel support (1). The invention also comprises a connecting rod (9) having an upper articulation point (10) which is connected to the cervical arm (7) and a lower articulation point (11) which is connected to the above-mentioned shaft support (4). In addition, the wheel support (1) includes a flange which serves as a limit stop (12) and which limits the movement of the cervical arm (7).

### TECHNICAL SECTOR

This invention, as has been stated in the heading to this descriptive report, refers to a massage device the main purpose of which is to obtain a device that is used in massage chairs, and similar items, that enables the giving of a neck massage of greater depth without the need to tighten the dorsal and lumbar areas any more, to which end the invention consists of a massage application element, which instead of the two corresponding wheels being coupled directly to the main support, one of these is attached to said support by means of an articulated arm and a connecting rod that are going to determine greater mobility in the corresponding wheel, thus enabling a more suitable depth for the neck massage.

### BACKGROUND ART

There are massage devices for massage chairs that have an eccentric rotating shaft support equipped with a coupling hole to said shaft and joined by means of a point of articulation to a massage wheel support. This support is fitted with an upper wheel and a lower wheel.

In conventional devices, both the upper wheel, as well as the lower wheel, articulate directly on the wheel support, in such a way as to give rise to problems by limiting certain movements as a result of the positioning of said wheels.

We do not know the current state-of-the-art of any massage device of the type that we have mentioned in which one of the massage wheels is not directly connected to the wheel support.

In order to achieve our aim and to avoid aforementioned problems, the invention consists of a massage device intended for a massage chair, the massage unit of which has a support for an eccentric rotating shaft equipped with a coupling hole to said shaft and which is connected by way of an articulation point to a massage wheel support that has an upper wheel and a lower wheel.

The novelty of the invention is that the upper wheel is connected to the support by means of a cervical arm in at least one massage unit, in such a way that the tip of the arm articulates with said upper wheel, while the other end of the arm has an articulation point with the wheel support. Moreover, the wheel support is fitted with a flange with an upper articulation point connected to the cervical arm and a lower articulation point that is connected to aforementioned shaft. The wheel support has a limit stop that serves to restrict the movement of the cervical arm.

The aforementioned device results in an upper and lower massage wheel drive system that depends on the position in which the massage system is set, in such a way that the upper massage wheel juts out more when than the lower wheel when the massage system is massaging the neck area; while in the back and lower back massage area the upper massage wheel retracts to the vertical line of the lower massage wheel. Notwithstanding, depending on the version, it is possible to reproduce or duplicate the invention device applied to the neck for other chair massage areas, such as, for example, the lower back area.

With this invention device, the massage wheels always try to adapt to the curvature of the spine, in such a way that the lower massage wheel that is fixed to the wheel support determines its pivoting, while at the upper part of the wheel support, the upper massage wheel on the cervical arm suitably pivots to adapt itself to the depth.

On the other hand, the fact that the cervical arm is connected to the support shaft by means of a flange serves to facilitate other suitable pivoting actions.

With the structure described above, the main advantage of the invention device is that the lower massage wheel, on coming nearer to or moving away from the back by following its contour, manages to drive aforementioned flange and its pivoting activates the cervical arm, thus making the upper massage wheel vary its vertical and horizontal position with respect to the lower massage wheel. In this way, when the lower massage wheel is at its most backward position during the neck massage, the upper massage wheel is at its most closed position, being restricted by the support wheel limit stop, while the opposite happens when the lower massage wheel is at its most forward position.

The position adopted by the upper massage wheel will depend on the length of the cervical arm and aforesaid flange, which can vary according to the version of the invention device.

In order to better understand this descriptive report, and forming an integral part of same, some explanatory drawings, albeit not exhaustive, are attached below to represent the invention in question.

### DESCRIPTION OF FIGURES

FIG. 1.—This affords us a perspective view of a massage device made in accordance with this invention.

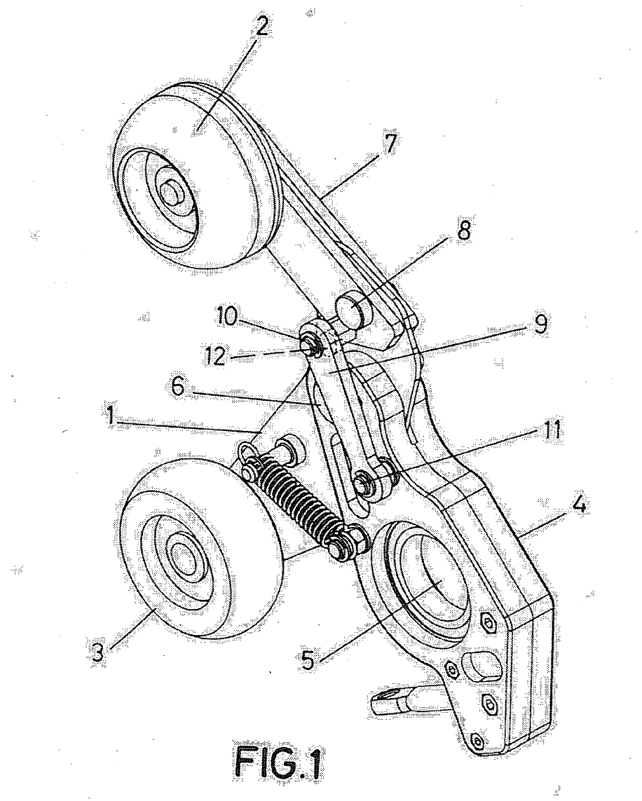

FIG. 2.—This affords us an elevation view of the device represented in FIG. 1 when its wheels are in the maximum opened position.

FIG. 3.—This shows an analogous view of FIG. 2, but when the device wheels are in the minimum closed position.

### BEST MODE

What follows is a description of an example of the invention using the reference numbers given in the drawings.

Thus, the massage device given in this example of the invention is intended for massage chairs and has an eccentric rotating shaft support (4) equipped with a coupling hole (5) to said shaft and joined by means of a point of articulation (6) to a wheel support that applies the massage (1).

This wheel support (1) is fitted with an upper wheel (2) and a lower wheel (3).

The upper wheel (2), instead of being connected directly to the wheel support (1), as is the case with the lower wheel (3), is connected to the wheel support (1) by means of a cervical arm (7), or cervical support, in such a way that one end of the arm (7) articulates with an upper wheel (2), while the other end of the arm has an articulation point (8) at which it is articulated with the wheel support (1).

Moreover, it is fitted with a flange (9) that has an upper articulation point that is connected to the cervical arm (7) and a lower articulation point (11) that is connected to the aforementioned shaft support (4).

Finally, the wheel support (1) is fitted with a limit stop (12) that restricts the movement of the cervical arm (7).

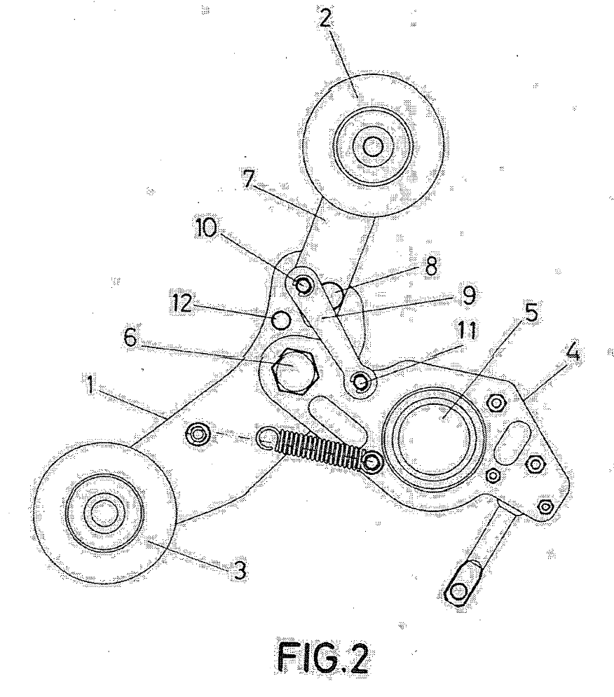

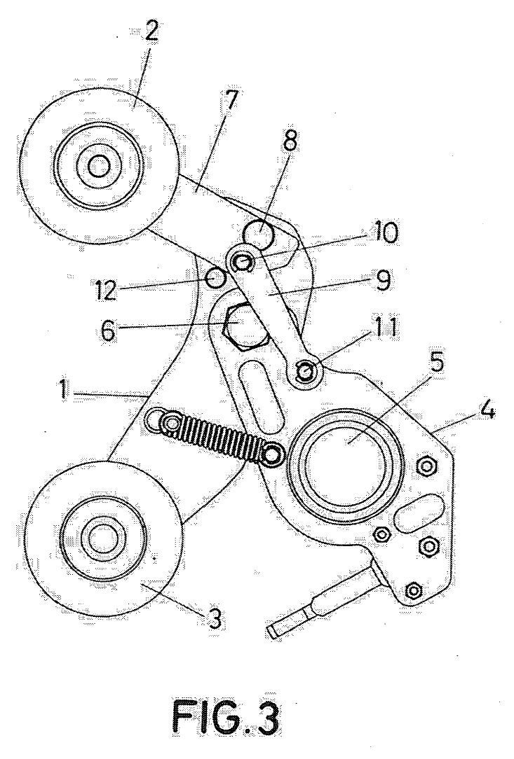

Consequently, pursuant to the current design and by means of articulation points 6, 8, 10 and 11 pivoting occurs that enables the upper wheel (2) to adapt to depth and height, to the extent of reaching the maximum open position as shown in FIG. 2, and a minimum closed position, determined by the limit stop (12), as shown in FIG. 3. This structure and manner of connecting the upper wheel (2) to the wheel support gives rise to a better adaptation of the massage device to the user's back by moving along same.

1. MASSAGE DEVICE which is intended for a massage chair, consisting of a support for an eccentric rotating shaft (4), which is equipped with a hole (5) for coupling said shaft thereto and which is joined at an articulation point (6) to a support (1) bearing two massage wheels, namely an upper wheel (2) and a lower wheel (3) characterised by at least in one device the upper wheel (2) is connected to the wheel support (1) by means of a cervical arm (7), such that one end of the arm (7) is articulated with the upper wheel (2), while the other end of the arm (7) is equipped with an articulation point (8) at which it is articulated with the wheel support (1); that also comprises a connecting rod (9) having an upper articulation point (10) which is connected to the cervical arm (7) and a lower articulation point (11) which is connected to the above-mentioned shaft support (4), in addition, the wheel support (1) includes a flange which serves as a limit stop (12) and which limits the movement of the cervical arm (7).
